(19) United States
(12) Patent Application Publication
(10) Pub. No.: US 2008/0095024 A1
(43) Pub. Date: Apr. 24, 2008

(54) Information Recording Medium

(76) Inventors: Toshio Suzuki, Saitama (JP); Kazuo Kuroda, Saitama (JP); Eiji Muramatsu, Saitama (JP)

Correspondence Address: YOUNG & THOMPSON, 745 SOUTH 23RD STREET, 2ND FLOOR, ARLINGTON, VA, 22202, US

(21) Appl. No.: 11/631,414

(22) PCT Filed: Jul. 4, 2005
(86) PCT No.: PCT/JP05/12332

§ 371 Date: Mar. 5, 2007

(30) Foreign Application Priority Data
Jul. 5, 2004 (JP) 2004-198522

(51) Int. Cl. G11B 7/013

(52) U.S. Cl. 369/275.3

(57) ABSTRACT

An information recording medium comprising a plurality of recording layers (L0 layer, L1 layer) for recording a plurality of pieces of recording information, respectively, wherein the first recording layer (L0 layer) located on the closest side when viewed from the side being irradiated with a laser beam has an identification information recording area (NBCA) previously recorded with information (e.g. media ID) for identifying the information recording medium.

### TECHNICAL FIELD

The present invention relates to an information recording medium, such as a DVD, for example.

### BACKGROUND ART

For example, with regard to an information recording medium, such as a DVD, there has been also developed a record type or read-only type optical disc of a multilayer type or dual layer (two layer) type in which a plurality of recording layers are laminated or stacked on the same substrate. Specifically, on an information recording apparatus, such as a DVD recorder, for recording information onto the two-layer record type optical disc, for example, laser light for recording is irradiated onto a recording layer located on the nearest side viewed from the irradiation side of laser light (hereinafter referred to as a “L0 layer”, as occasion demands), by which the information is recorded into the L0 layer in a rewritable method (e.g. aimed at a DVD-R/W) or irreversible change recording method by heat or the like (e.g. aimed at a DVD-R), and the laser light is irradiated onto a recording layer located on the rear side of the L0 layer viewed from the irradiation side of laser light (hereinafter referred to as a “L1 layer”, as occasion demands), by which the information is recorded into the L1 layer in the rewritable method or irreversible change recording method by heat or the like.

On the other hand, a patent document 1 or the like discloses a distribution or delivery system for recording in advance identification information, such as media ID, peculiar to an information recording medium, or encryption information onto the record type information recording medium, such as a DVD-R/RW, selling it, and delivering encrypted DVD video contents (hereinafter referred to as “encrypted contents”, as occasion demands) through a network. The encryption is performed in accordance with an encrypted system described in a non-patent document 1, for example. This distribution system uses the information recording medium having the same physical structure that of the conventional record type information recording medium, such as the DVD-R/RW.

Moreover, in the two-layer read-only type information recording medium, such as a two-layer type DVD-ROM, the identification information peculiar to the information recording medium and the identification information about a manufacturer's identification number (serial number) or the like of application software recorded in advance on the information recording medium are prerecorded in a recording method different from the recording method used in a data area, such as a user data area. More specifically, high-powered laser light, such as a YAG laser, for example, is irradiated to penetrate into the two recording layers, i.e. irradiated to burn off the recording layer of the L0 layer, the reflective layer of the L0 layer, and the recording layer of the L1 layer, by which the identification information is prerecorded in a BCA (Barcode Cutting Area) in a barcode shape.

Patent document 1: Japanese Patent Application Laying Open NO. 2001-307427

Patent document 2: Japanese Patent Application Laying Open NO. 2001-357001

Patent document 3: Japanese Patent Application Laying Open NO. 2000-331412

Nonpatent document 1: “DVD content protection”, Toshiba review, Vol. 58, No 6 (2003)

### DISCLOSURE OF INVENTION

### Subject to be Solved by the Invention

However, in the case of the multilayer record type information recording medium, such as the two-layer type DVD-R/RW, for example, if the identification information is prerecorded in a NBCA (Narrow Barcode Cutting Area) in the recording method that the high-powered laser light, such as a YAG laser, for example, is irradiated to penetrate into each recording layer, as in the conventional two-layer type DVD-ROM, physical features in the pigment film of each entire recording layer deteriorate, so that there is such a technical problem that it remarkably reduces the reliability as the record type information recording medium.

Moreover, in the case of the multilayer record type information recording medium, it is desirable that recording control information, which is unique to each recording layer, is recorded in all the recording layers. However, the above-mentioned identification information indicates the information peculiar to one information recording medium, and if it is prerecorded in all the recording layers, it consumes a data capacity uselessly, so that there is such a technical problem that it is hardly possible to effectively use recording areas. Moreover, even in the multilayer read-only type information recording medium, if the identification information is prerecorded in one recording layer by using the high-powered laser light, there is also such a technical problem that it is hardly possible to effectively use the recording areas in facing another recording layer.

In order to solve the above-mentioned conventional problems, it is therefore an object of the present invention to provide an information recording medium which enables the prerecording of the identification information with the effective utilization of the recording area, on the multilayer record type information recording medium, for example.

### Means for Solving the Object

(Information Recording Medium)

The above object of the present invention can be achieved by an information recording medium provided with: a plurality of recording layers, each of which is to record therein a plurality of record information, a first recording layer (e.g. L0 layer) located on a nearest side viewed from a laser light irradiation side, out of the plurality of recording layers, having an identification information recording area (e.g. NBCA) in which identification information for identifying the information recording medium is prerecorded.

According to the information recording medium of the present invention, for example, the first recording layer and at least another one recording layer are laminated on one side of a disc-shaped substrate, for example, and the information recording medium is a two-layer type or multilayer type DVD or optical disc, or the like. In the first recording layer, the record information, such as audio, video information or content information, for example, can be recorded. In the same manner, in at least another one recording layer, the record information, such as audio, video information or content information, for example, can be recorded. By virtue of such construction, laser light for recording or reproduction is irradiated on the substrate, the first recording layer, and at least another one recording layer, in this order, for example.

In the present invention, the first recording layer, such as a L0 layer, for example, located on the nearest side viewed from the laser light irradiation side, has the identification information recording area, such as a NBCA, for example, in which the identification information, such as media ID, is recorded. More specifically, the identification information is recorded into the identification information recording area, as follows. Firstly, laser light for initializing the record type information recording medium, which is different from the laser light in the normal recording, is irradiated in an elliptical shape into a range of several tracks, for example, by a prerecording apparatus, such as an initializer, for example. By modulating the irradiation of the laser light, the identification information is prerecorded into the identification information recording area, as barcode information. Incidentally, in the prerecording, tracking servo, which is the normal recording operation, is not performed, and the rotation of a stepping motor is controlled only on the basis of a position sensor.

As a result, an information recording/reproducing apparatus, such as a DVD player, for example, can quickly obtain the identification information, by an initial operation, such as a seek operation, for example, simultaneously with or in tandem with the obtainment of other control information.

If another recording layer other than the first recording layer has the identification information recording area, in order to obtain the identification information when the information recording/reproducing apparatus (i) accesses the record information, such as user data, recorded in a record information recording area, such as a user data area, and (ii) executes an application program recorded in the record information recording area, it is necessary to access the another recording layer from the currently accessing recording layer, to thereby obtain the identification information. As described above, the operation of obtaining the identification information is performed by the information recording/reproducing apparatus, independently of the initial operation, so that it takes more time redundantly.

As opposed to this, according to the present invention, it is possible to greatly reduce a setting time for the reproduction of the record information, for example, by disposing the identification information recording area with the identification information prerecorded, in the recording layer which can be accessed by the information recording/reproducing apparatus, more simply and easily, on the multilayer record type optical disc, for example. In other words, by that the information recording/reproducing apparatus searches the smallest range on the information recording medium, it is possible to reduce a time length of obtaining the control information about the reproduction and the recording in addition to the identification information, and also it is possible to obtain more various information.

Moreover, the identification information recording area with the identification information prerecorded is disposed only in the first recording layer. Thus, it is possible to effectively use the recording areas of the facing another recording layer.

Furthermore, by disposing the identification information recording area in the first recording layer, such as the L0 layer, it is possible to match the recording-layer-accessing order in the initial operation of the information recording/reproducing apparatus, such as the existing DVD player, to thereby maintain compatibility.

In one aspect of the information recording medium of the present invention, the identification information is information peculiar to the information recording medium.

According to this aspect, it is possible to specify the information recording medium, as one and only one unique information recording medium, on the basis of encryption information described later, for example, in addition to the identification information.

As a result, it is possible to realize the copyright protection of the record information, such as contents, which can be recorded on the information recording medium, in a distribution system, for example.

In another aspect of the information recording medium of the present invention, the first recording layer (L0 layer), another recording layer or another recording layers out of the plurality of recording layers, has an encryption information recording area to record therein encryption information, which corresponds to the identification information, for encrypting one portion of the plurality of record information.

According to this aspect, it is possible to specify the information recording medium, as one and only one unique information recording medium, on the basis of the identification information in addition to the encryption information.

As a result, it is possible to realize the copyright protection of the record information, such as contents, which can be recorded on the information recording medium, in the distribution system, for example.

In another aspect of the information recording medium of the present invention, the first recording layer (L0 layer) further has a control information recording area (control data zone) in which control information for controlling reproduction and recording of the plurality of record information can be recorded.

According to this aspect, the first recording layer, such as the L0 layer, further has the control information recording area, such as a control data zone, for example, in which the control information for controlling the reproduction and recording is recorded.

As a result, an information recording/reproducing apparatus, such as a DVD player, for example, can more quickly obtain the above-mentioned identification information, by the initial operation, such as a seek operation, for example, simultaneously with or in tandem with the obtainment of the control information.

In other words, by disposing (i) the identification information recording area with the identification information prerecorded and (ii) the control information recording area in the same recording layer on the multilayer record type information recording medium, for example, the information recording/reproducing apparatus can access the identification information recording area and the control information recording area, more simply and easily, and it is possible to greatly reduce a setting time for the reproduction of the record information, for example.

In an aspect associated with the control information recording area, flag information indicating whether or not there is the identification information recording area (NBCA) can be recorded in the control information recording area (control data zone).

By virtue of such construction, the information recording/reproducing apparatus, such as a DVD player, for example, can obtain the flag information indicating whether or not there is the identification information recording area, by the initial operation, such as a seek operation, for example, simultaneously with or in tandem with the obtainment of the control information.

Therefore, it is possible to obtain the above-mentioned identification information, more efficiently, more quickly, and accurately.

In another aspect of the information recording medium of the present invention, each of the plurality of recording layers has a record information recoding area in which a land track and a groove track are alternately formed as a record track for recording the plurality of record information, and in the identification information recording area, the groove track is divided in a direction along the groove track by a spatial frequency not less than a predetermined spatial frequency (2NA/λ) at which reproduction can no longer be performed on the basis of an optical transfer characteristic (MTF) of a reproduction optical system.

According to this aspect, as a first characteristic, in the identification information recording area, the groove track is divided in the direction along the groove track by the spatial frequency not less than the predetermined spatial frequency (unit is “the number of tracks per millimeter”) at which reproduction can no longer be performed on the basis of the optical transfer characteristic (MTF: Modulation Transfer Function) of the reproduction optical system. The “predetermined spatial frequency” herein is determined on the basis of (i) the numerical aperture (NA) of the reproduction optical system, such as the objective lens of an optical pickup, for example, and (ii) the wavelength of the laser light. More specifically, if the spatial frequency is relatively small, the length of a groove which is one divided unit is relatively large, and the optical transfer characteristic, i.e. a reproduction level, is relatively large and approximates “1”. On the other hand, if the spatial frequency is greater than the “predetermined spatial frequency”, the length of the groove which is one divided unit is relatively small, and the optical transfer characteristic, i.e. the reproduction level, is “0: zero”.

As a result, a modulation signal obtained from the divided groove track is hardly superimposed or not superimposed at all, on a reproduction RF signal obtained from the identification information prerecorded as the barcode information in the identification information recording area of one recording layer.

Moreover, in this aspect, as a second characteristic, by adjusting the “predetermined spatial frequency” which divides the groove track, it may be constructed to set optical transmittance of (at least) one portion of the identification information recording area in which barcode information for carrying (at least) one portion of the identification information is not recorded, closer to optical transmittance of another portion of the identification information recording area in which the barcode information is recorded, than optical transmittance when it is assumed that the groove track is not divided by the predetermined spatial frequency and the barcode information is not recorded. In addition, it is more preferable that the optical transmittance of one portion of the identification information recording area is equalized the optical transmittance of another portion of the identification information recording area. Here, the expression “is equalized” includes not only a meaning of completely identical, but also a meaning of the same to the extent that can be regarded identical, when the record information recorded in another recording layer is reproduced, for example.

As a result, if another recording layer is focused on (if the focal point is on another recording layer) which is located on the farther side (or rear side) than the first recording layer viewed from the laser light irradiation side, it is possible to almost or completely uniform the optical transmittance of the laser light irradiated on the first recording layer with it defocused (vaguely), averagely as a whole, regardless of (i) the area with the barcode information recorded or (ii) the area without the barcode information in the identification information recording area of the first recording layer. Therefore, the modulation signal, obtained from the identification information recorded as the barcode information in the identification information recording area of the first recording layer, is hardly superimposed or not superimposed at all on the reproduction RF signal obtained from the record information recorded in the record information recording area of the another recording layer located on the farther side than the first recording layer.

As described above, it is possible to prerecord the identification information, properly and accurately, in the identification information recording area of the first recording layer, due to the above-mentioned first and second characteristics. In addition, the first and second characteristics allow no influence on the reproduction of the record information recorded in another recording layer. Therefore, it is possible to effectively use the recording areas of at least another one recording layer facing the identification information recording area.

In an aspect associated with the spatial frequency, the predetermined spatial frequency may be determined on the basis of numerical aperture (NA) of the reproduction optical system and a wavelength (λ) of laser light.

According to this aspect, the predetermined spatial frequency “X” can be calculated from the following equation (1).
X=2NA/λ (1)

wherein, “NA” is the numerical aperture (NA) of the reproduction optical system, such as the objective lens of the optical pickup, for example, and “λ” is the wavelength of the laser light.

As a result, it is possible to calculate the predetermined spatial frequency, more properly and accurately.

These effects and other advantages of the present invention will become more apparent from the following embodiments.

As explained above, according to the information recording medium of the present invention, the first recording layer (L0 layer), located on the nearest side viewed from the laser light irradiation side, out of the plurality of recording layers, has the identification information recording area (NBCA) in which the identification information for identifying the information recording medium is prerecorded. Thus, it is possible to greatly reduce a setting time for the reproduction of the record information, for example, by disposing the identification information recording area with the identification information prerecorded, in the recording layer which can be accessed by the information recording/reproducing apparatus, more simply and easily, on the multilayer record type optical disc, for example.

### BRIEF DESCRIPTION OF DRAWINGS

FIG. 1 are a substantial plan view showing the basic structure of an optical disc having a plurality of recording areas in a first embodiment of the information recording medium of the present invention (FIG. 1(a)), and a schematic cross sectional view of the optical disc and a corresponding conceptual diagram showing a recording area structure in the radial direction (FIG. 1(b)).

FIG. 2 is a partially enlarged perspective view showing the recording surface of the optical disc in the first embodiment of the information recording medium of the present invention.

FIG. 3 is a schematic cross sectional view showing a detailed data structure centered on a NBCA of a L0 layer on the two-layer type optical disc in the first embodiment of the information recording medium of the present invention.

FIG. 4 is a schematic cross sectional view showing a detailed data structure centered on the NBCA in the L0 layer on the two-layer type optical disc in a first comparison example.

FIG. 5 are a conceptual cross sectional view showing the reproduction principle of identification information prerecorded in the NBCA of the L0 layer on the two-layer type optical disc in the first embodiment of the information recording medium of the present invention (FIG. 5(a)), and a conceptual cross sectional view showing the reproduction principle of record information recorded in the recording area of the L1 layer facing at least one portion of the NBCA (FIG. 5(b)).

FIG. 6 is a graph showing a correlation between an optical transfer characteristic (MTF: Modulation Transfer Function) and a spatial frequency for dividing a groove track in the NBCA of the L0 layer of the two-layer type optical disc in the first embodiment of the information recording medium of the present invention.

FIG. 7 is a conceptual cross sectional view showing the reproduction principle of the identification information prerecorded in the NBCA of the L0 layer on the two-layer type optical disc in a second comparison example.

FIG. 8 is a schematic top view conceptually showing light transmittance in such an area that the identification information is prerecorded as barcode information, and in such an area that it is not prerecorded, in the NBCA of the L0 layer on the two-layer type optical disc in the first embodiment of the information recording medium of the present invention.

FIG. 9 are a conceptual cross sectional view showing the reproduction principle of the identification information prerecorded in the NBCA of the L0 layer on the two-layer type optical disc in a third comparison example (FIG. 9(a)), and a conceptual cross sectional view showing the reproduction principle of the record information recorded in the recording area of the L1 layer facing at least one portion of the NBCA (FIG. 9(b)).

FIG. 10 is a schematic cross sectional view showing a detailed data structure centered on the NBCA in the L0 layer on a two-layer type optical disc in a second embodiment of the information recording medium of the present invention.

### DESCRIPTION OF REFERENCE CODES

1 . . . center hole, 10 . . . track, 11 . . . sector, 100 . . . optical disc, 101-0 (101-1) . . . lead-in area, 102-0 (102-1) . . . data area, 103-0 (103-1) . . . lead-out area, 104-0, 104-1 . . . middle area, 106 . . . transparent substrate, 107 . . . one recording layer, 107a . . . pigment film, 108 . . . semitransparent reflective film, 109 . . . wobble, 205 . . . middle layer, 207 . . . another recording layer, 208 . . . reflective film, GT . . . groove track, LT . . . land track, LB . . . laser light, LP . . . land pre-pit, PCA0 (PCA1) . . . OPC area, RMA (RMA1, RMA2) . . . Recording Management Area or the like, NBCA . . . Narrow Barcode Cutting Area, INI . . . initial zone, CDZ . . . control data zone, Key1 (Key2) . . . encryption information

### BEST MODE FOR CARRYING OUT THE INVENTION

Hereinafter, the best mode for carrying out the present invention will be discussed by giving embodiments on the basis of the drawings.

### First Embodiment of Information Recording Medium

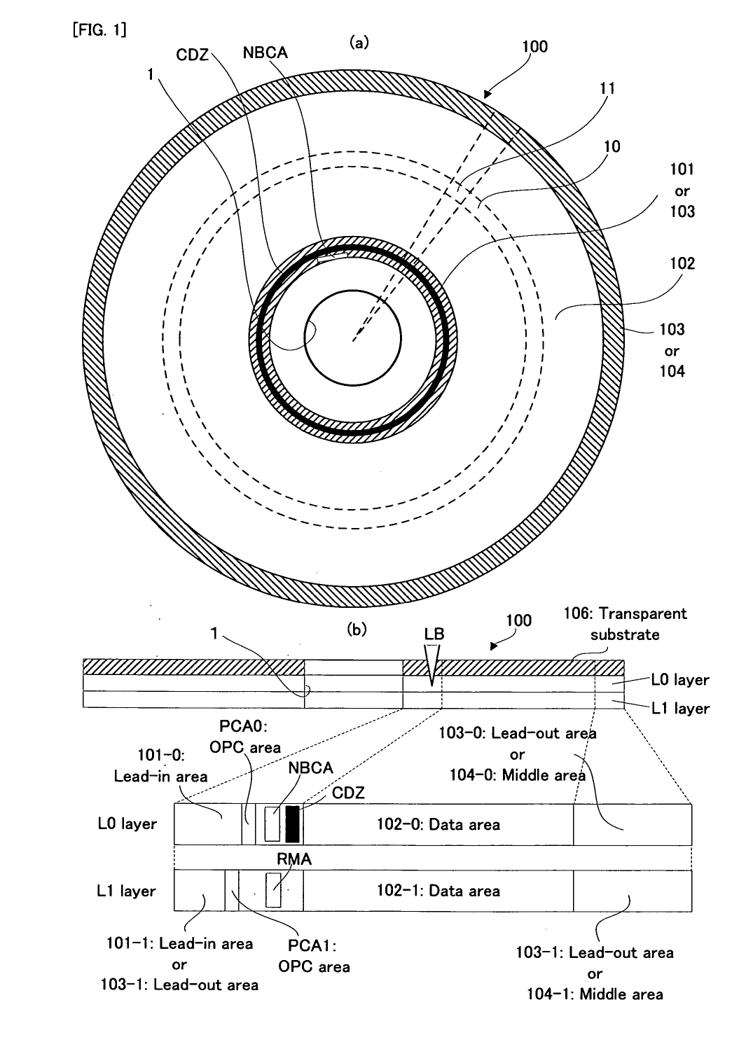

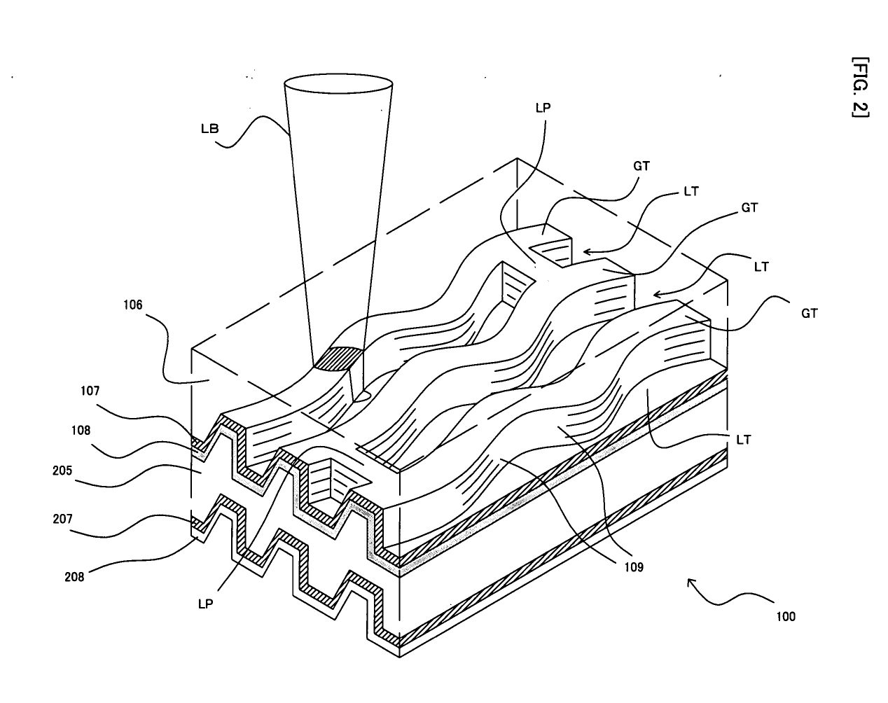

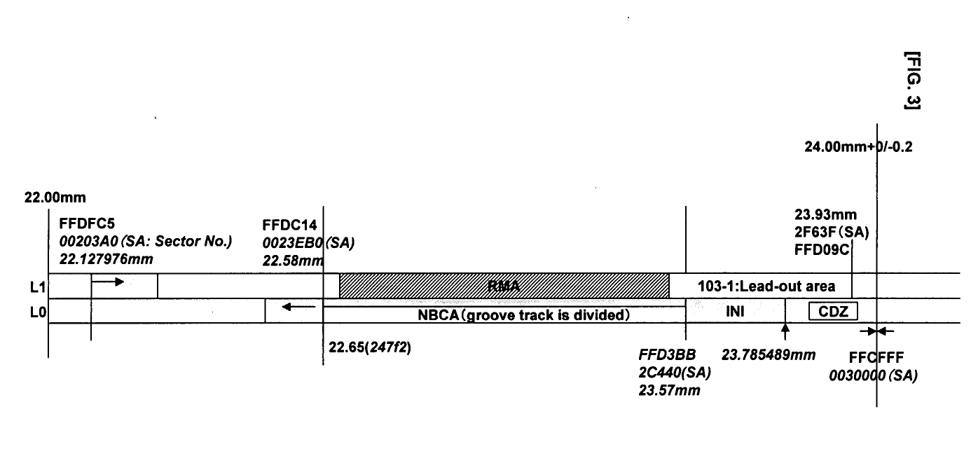

Next, with reference to FIG. 1 to FIG. 6, an optical disc in a first embodiment of the information recording medium of the present invention will be explained in detail, on the basis of the drawings. Incidentally, for convenience of explanation, in FIG. 1 and FIG. 2, laser light is irradiated from the upper side to the lower side. Thus, the L0 layer (first recording layer) is located on the upper side. On the other hand, in FIG. 3 to FIG. 5 and FIG. 7 to FIG. 10, the laser light is irradiated from the lower side to the upper side. Thus, the L0 layer (first recording layer) is located on the lower side.

Firstly, with reference to FIG. 1, an explanation will be given to the basic structure of the optical disc in the first embodiment of the information recording medium of the present invention. FIG. 1(a) is a substantial plan view showing the basic structure of the optical disc having a plurality of recording areas in the first embodiment of the information recording medium of the present invention, and FIG. 1(b) is a schematic cross sectional view of the optical disc and a corresponding conceptual diagram showing a recording area structure in the radial direction. Incidentally, the information recording medium in the first embodiment is an additional recording (write-once) type optical disc which uses an organic pigment film. Incidentally, as described later, the information recording medium in the first embodiment may be a rewritable type optical disc on which the recording can be performed a plurality of times by various irreversible change recording methods by heat or the like and the reproduction can be also performed a plurality of times.

Particularly, an optical disc 100 in the embodiment, as shown in FIG. 1(b), has such a structure that the L0 layer and the L1 layer, which constitute one example of the “first and second record layers” of the present invention as descried later, respectively, are laminated on a transparent substrate 106, for example. Upon the recording/reproduction of such a dual-layer type optical disc 100, the recording/reproduction in the L0 layer or the L1 layer is performed, depending on which recording layer has the focus position of laser light LB, irradiated from the upper side to the lower side in FIG. 1(b).

As shown in FIG. 1(a) and FIG. 1(b), the optical disc 100 has a recording surface on a disc main body with a diameter of about 12 cm, as is a DVD. On the recording surface, the optical disc 100 is provided with: a center hole 1 as the center; a lead-in area 101; a data recording area 102; and a lead-out area 103 or a middle area 104 as a buffer area, which are associated with the first embodiment. In particular, for example, the lead-in area 101 is provided with an OPC area PCA0 or PCA1 for performing an OPC process. Then, the recording layers or the like are laminated on the transparent substrate 106 of the optical disc 100, for example. Then, in each recording area of the recording layers, a track or tracks 10, such as groove tracks and land tracks, are alternately placed, spirally or concentrically, centered on the center hole 1. Moreover, on the track 10, data is divided and recorded by a unit of ECC block 11. The ECC block 11 is a data management unit by a pre-format address in which record information is error-correctable.

A lead-in area 101-0 of the L0 layer is provided with: an OPC area PCA0; a NBCA (Narrow Burst Cutting Area); and a control data zone CDZ, from the inner to the outer circumferential side.

The OPC area PCA0 is an area to test-write therein test writing information for determining an optimum recording power when the record information is recorded into the L0 layer. Specifically, the OPC area PCA0 and the OPC area PCA1 described later are used for the calibration process of a recording laser power, i.e. the OPC process. More specifically, after the test writing of an OPC pattern is completed, the test-written OPC pattern is reproduced, and the reproduced OPC pattern is sampled sequentially, to thereby detect the optimum recording power. Moreover, the value of the optimum recording power obtained by the OPC process may be recorded into a recoding management area RMA described later, or stored in a storage apparatus, such as a memory described later, mounted on the information recording apparatus side. Alternatively, the OPC process may be performed at each time of the recording operation.

In the control data zone CDZ, encryption information Key1, such as a disk key and a disk key set, based on a predetermined encryption system is recorded in addition to control information for controlling the reproduction and the recording with respect to the optical disc 100. Incidentally, the encryption information Key1, such as a disk key and a disk key set, constitutes one specific example of the “encryption information” of the present invention. Moreover, the control data zone CDZ constitutes one specific example of the “control information recording area” of the present invention.

In the NBCA, the “identification information” of the present invention, such as a manufacturer's serial number peculiar to each optical disc 100, i.e. media ID, is recorded as barcode information by laser cutting.

On the other hand, a lead-in area 101-1 of the L1 layer is provided with: an OPC area PCA1; and a recording management area RMA, which constitutes one example of the “recording control information recording area” of the present invention, from the inner to the outer circumferential side.

The OPC area PCA1 is an area to test-write therein the test writing information for determining the optimum recording power when the record information is recorded into the L1 layer.

In the recording management area RMA, the value of the optimum recording power calculated by the test writing in the OPC areas PCA0 and PCA1 is recorded in accordance with predetermined order.

In data areas 102-0 and 102-1, encryption information Key2, such as a title key, based on the encryption system, and encrypted contents encrypted by the encryption information Key2, such as a title key, are recorded. More specifically, the encryption information Key2, such as a title key, is encrypted by using the encryption information Key1, such as a disk key and a disk key set.

Incidentally, the present invention is not particularly limited to the optical disc having these three areas. For example, even if the lead-in area 101, the lead-out area 103 or the middle area 104 does not exist, a data structure explained below can be constructed. Moreover, as described later, the lead-in area 101, the lead-out area 103 or the middle area 104 may be further segmentalized.

Moreover, the optical disc 100 in the embodiment is not limited to a two-layer single sided type, i.e., a dual layer type, but may be a two-layer double sided type, i.e., a dual layer double sided type. Furthermore, the optical disc 100 in the embodiment is not limited to the optical disc having the two recording layers, as described above, but may be an optical disc of a multilayer type which has three or more layers.

Incidentally, a recording/reproducing procedure on the two-layer type optical disc may be an opposite method in which the directions of track paths are opposite between the two recording layers, for example, or may be a parallel method in which the directions of track paths are the same between the two recording layers, for example.

Next, with reference to FIG. 2, an explanation will be given for the outline of the physical structure of the optical disc in the first embodiment of the information recording medium of the present invention. More specifically, the optical disc 100 in the first embodiment is constructed as the two-layer type optical disc on which a plurality of data zones 102 or the like are formed in a lamination structure, for example. FIG. 2 is a partially enlarged perspective view showing the recording surface of the optical disc in the first embodiment of the information recording medium of the present invention.

As shown in FIG. 2, in the first embodiment, the optical disc 100 has a first recording layer (L0 layer) 107 of a phase change type or of an irreversible change recording type (pigment type) by heat or the like, which constitutes an information recording surface, laminated on the lower side of the disc-shaped transparent substrate 106, and further has a semitransparent reflective film 108 on the lower side thereof. On the information recording surface constructed from the surface of the first recording layer 107, a groove track GT and a land track LT are alternately formed. Incidentally, upon recording and reproduction of the optical disc 100, for example, as shown in FIG. 2, the groove track GT is irradiated with laser light LB through the transparent substrate 106. For example, upon recording, the laser light LB is irradiated with a recording laser power, to thereby perform the writing by a phase change or the irreversible change recording by heat or the like, with respect to the first recording layer 107 in accordance with the record data. On the other hand, upon reproduction, the laser light LB is irradiated with a reproduction laser power weaker than the recording laser power, by which the record data written in the first recording layer 107 is read.

In the first embodiment, the groove track GT is oscillated with a constant amplitude and at a constant spatial frequency. In other words, the groove track GT is wobbled, and the cycle of the wobble 109 is set to a predetermined value. On the land track LT, there is formed an address pit which is referred to as a land pre-pit LP and which indicates pre-format address information. By virtue of the two addressing (i.e. the wobble 109 and the land pre-pit LP), it is possible to obtain information necessary for (i) disc rotation control during the recording, (ii) generation of a recording clock, or (iii) data recording, such as a recording address. Incidentally, it is also possible to record the pre-format address in advance, by modulating the wobble 109 of the groove track GT in a predetermined modulation method, such as frequency modulation and phase modulation.

Particularly in the first embodiment, a second recording layer (L1 layer) 207 is formed on the lower side of the semitransparent reflective film 108, and moreover, a reflective film 208 is formed on the lower side thereof. The second recording layer 207 is constructed such that the recording and reproduction of the phase change type or of the irreversible change recording type (pigment type) by heat or the like can be performed in substantially the same manner as the first recording layer 107, by irradiating the laser light LB through the transparent substrate 106, the first recording layer 107, and the semitransparent reflective film 108. With regard to the second recording layer 207 and the reflective film 208, they may be laminated, i.e. film-formed, on the transparent substrate 106 on which the first recording layer 107 and the semitransparent reflective film 108 or the like are formed. Alternatively, after each of them is laminated, i.e. film-formed, on a different substrate, they may be pasted to the transparent substrate 106. Incidentally, between the semitransparent reflective film 108 and the second recording layer 207, there is provided a transparent middle layer 205 constructed from a transparent adhesive or the like, as occasion demands, according to the manufacturing method.

Upon the recording and reproduction of such a two-layer type optical disc 100, the recording and reproduction in the first recording layer 107 or the second recording layer 207 is performed, depending on which recording layer has the focus position of the laser light LB, that is, which recording layer is focused on.

(Data Structure centered on NBCA, and Reproduction Principle of Identification Information etc.)

Next, with reference to FIG. 3 to FIG. 6, an explanation will be given for a detailed data structure centered on the NBCA of the L0 layer on the two-layer type optical disc in the first embodiment of the information recording medium of the present invention, and the reproduction principle of the identification information prerecorded in the NBCA of the L0 layer and the reproduction principle of the record information recorded in the recording area of the L1 layer facing at least one portion of the NBCA.

(Data Structure Centered on NBCA)

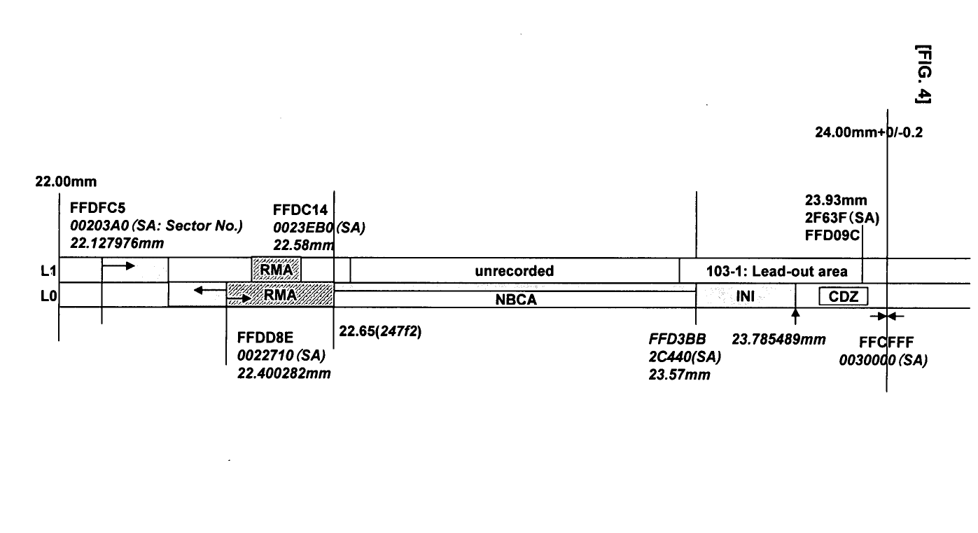

Firstly, with reference to FIG. 3 and FIG. 4, an explanation will be given for the detailed data structure centered on the NBCA of the L0 layer on the two-layer type optical disc in the first embodiment of the information recording medium of the present invention, including the study of its operation and effects. FIG. 3 is a schematic cross sectional view showing the detailed data structure centered on the NBCA of a L0 layer on the two-layer type optical disc in the first embodiment of the information recording medium of the present invention. FIG. 4 is a schematic cross sectional view showing the detailed data structure centered on the NBCA in the L0 layer on the two-layer type optical disc in a first comparison example.

As shown in FIG. 3, the optical disc 100 has the two recording layers, i.e. the L0 layer (i.e. the recording layer corresponding to the first recording layer 107 in FIG. 1 and FIG. 2) and the L1 layer (i.e. the recording layer corresponding to the second recording layer 207 in FIG. 1 and FIG. 2). Incidentally, for convenience of explanation, the laser light LB for recording is irradiated from the lower side to the upper side, as opposed to FIG. 1 and FIG. 2.

The lead-in area 101-0 of the L0 layer is provided with: the OPC area PCA0; the NBCA; an initial zone INI; and the control data zone CDZ, from the inner to the outer circumferential side.

Specifically, with regard to the OPC area PCA0, the position in the radial direction is 22.127976 to 22.58 mm (millimeter). However, the test writing is performed from the outer to the inner circumferential side in this range. Incidentally, in FIG. 3 in the first embodiment, the address by the opposite method is shown but the parallel method may be adopted.

With regard to the NBCA, the position in the radial direction is 22.58 to 23.57 mm. More specifically, the position in the radial direction of the start point of the NBCA may be shifted from 22.71 mm to the inner or outer circumferential side by 0.06 mm. Moreover, the position in the radial direction of the end point of the NBCA may be shifted from 23.51 mm to the inner or outer circumferential side by 0.06 mm. Particularly in the first embodiment, the groove track in the NBCA may be divided by a spatial frequency not less than a predetermined spatial frequency.

The initial zone INI may be provided in a range of 23.57 to 23.785489 mm in the position in the radial direction. In the initial zone INI, dummy data, such as zero, is recorded, for example.

The control data zone CDZ may be provided in a range of 23.785489 to 24.00 mm in the position in the radial direction, or may be provided in a range of 002F200 to 002FEOO in the sector number.

On the other hand, the lead-in area 101-1 of the L1 layer is provided with: the OPC area PCA1; and the recording management area RMA, from the inner to the outer circumferential side.

Specifically, with regard to the OPC area PCA1, as in the OPC area PCA0, the position in the radial direction is 22.127976 to 22.58 mm. However, the test writing is performed from the inner to the outer circumferential side in this range.

The recording management area RMA is provided in the recording area facing at least one portion of the NBCA of the L0 layer. The position in the radial direction of the innermost edge of the recording management area RMA is shifted to the outer circumferential side by an eccentric amount of 0.2 mm or the like, for example, from the position in the radial direction of the innermost edge of the NBCA. On the other hand, even the position in the radial direction of the outermost edge of the recording management area RMA is shifted to the inner circumferential side by an eccentric amount of 0.2 mm or the like, for example, from the position in the radial direction of the outermost edge of the NBCA.

As described above, the NBCA is provided in the L0 layer in the same manner as in the control data zone CDZ. By this, an information recording/reproducing apparatus, such as a DVD player, for example, can quickly obtain the identification information prerecorded in the NBCA by its initial operation, such as a seek operation, for example, simultaneously with or in tandem with the obtainment of the other control information recorded in the control data zone CDZ.

If another recording layer other than the L0 layer has the NBCA, in order to obtain the identification information when the information recording/reproducing apparatus accesses the record information, such as user data, recorded in the data area and executes an application program recorded in the data area, it is necessary to access the another recording layer from the currently accessing recording layer, to thereby obtain the identification information. As described above, the operation of obtaining the identification information is performed by the information recording/reproducing apparatus, independently of the initial operation, so that it takes more time redundantly.

As opposed to this, according to the first embodiment, it is possible to greatly reduce a setting time for the reproduction of the record information, for example, by disposing the NBCA with the identification information prerecorded, in the L0 layer which can be accessed by the information recording/reproducing apparatus, more simply and easily, on the two-layer type optical disc, for example. In other words, by that the information recording/reproducing apparatus searches the smallest range on the optical disc, it is possible to reduce a time length of obtaining the control information about the reproduction and the recording in addition to the identification information, and also it is possible to obtain more various information.

Moreover, the NBCA with the identification information prerecorded is disposed only in the L0 layer. Thus, by disposing the recording management area RMA in the recording area of the facing L1 layer, it is possible to effectively use the recording areas.

If, as shown in FIG. 4, the identification information is prerecorded in the NBCA of the L0 layer by using high-powered laser light, such as a YAG laser, for example, the laser light also penetrates into the L1 layer. Thus, the pigment film of the L1 layer irreversibly changes, and it is difficult to record the other record information. Thus, it is necessary to consider the eccentric amount in the L0 layer and the L1 layer, and also distribute and dispose the recording management area RMA into the two layers. Therefore, the data capacity is consumed uselessly, so that it is hardly possible to effectively use the recording areas.

As opposed to this, according to the first embodiment, the NBCA with the identification information prerecorded is disposed only in the L0 layer. Thus, it is possible to dispose and effectively use the recording management area RMA in the recording area of the facing L1 layer.

Moreover, by disposing the identification information recording area in the first recording layer, such as the L0 layer, it is possible to match the recording-layer-accessing order in the initial operation of the information recording/reproducing apparatus, such as the existing DVD player, to thereby maintain compatibility.

(Reproduction Principle of Identification Information, Etc.)

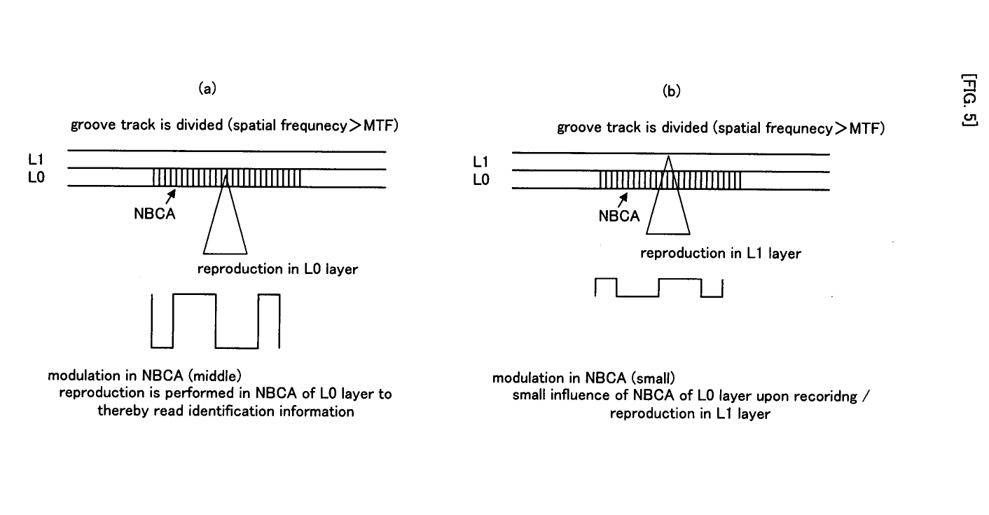

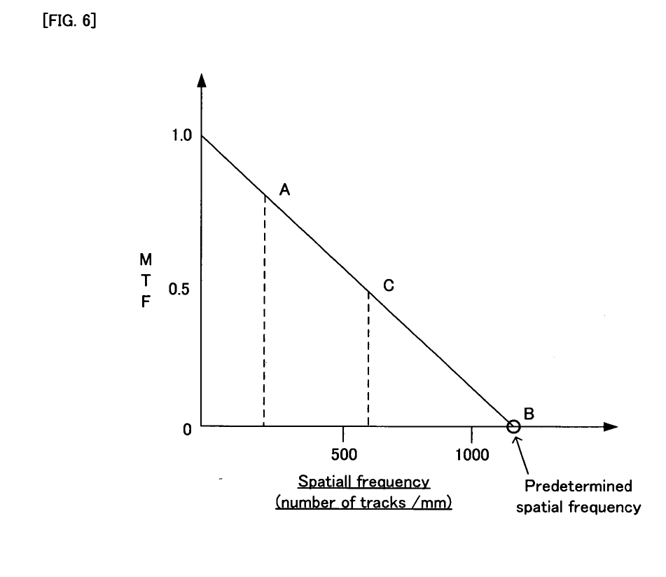

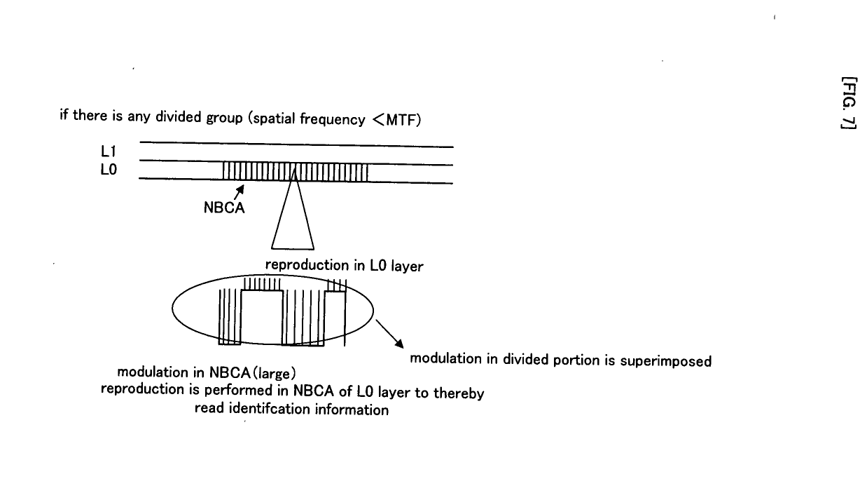

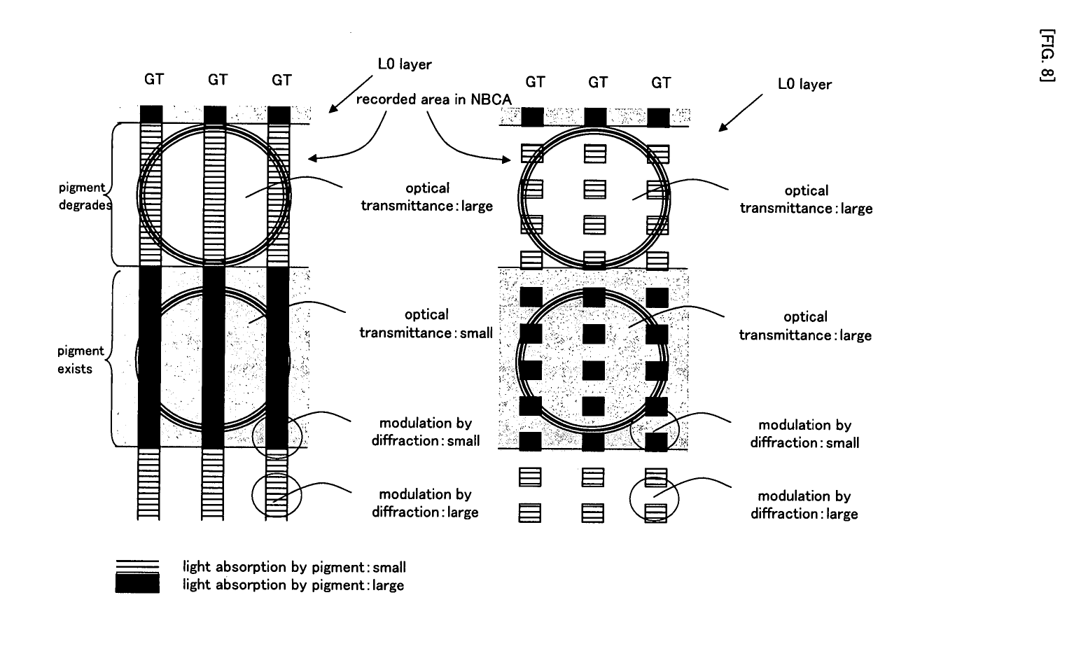

Next, with reference to FIG. 5 to FIG. 9, an explanation will be given for (i) the reproduction principle of the record information prerecorded in the NBCA of the L0 layer on the two-layer type optical disc in the first embodiment of the information recording medium of the present invention, and (ii) the reproduction principle of the record information recorded in the recording area of the L1 layer facing at least one portion of the NBCA. FIG. 5 are a conceptual cross sectional view showing the reproduction principle of the identification information prerecorded in the NBCA of the L0 layer on the two-layer type optical disc in the first embodiment of the information recording medium of the present invention (FIG. 5(a)), and a conceptual cross sectional view showing the reproduction principle of the record information recorded in the recording area of the L1 layer facing at least one portion of the NBCA (FIG. 5(b)). FIG. 6 is a graph showing a correlation between an optical transfer characteristic (MTF: Modulation Transfer Function) and a spatial frequency for dividing the groove track in the NBCA of the L0 layer of the two-layer type optical disc in the first embodiment of the information recording medium of the present invention. FIG. 7 is a conceptual cross sectional view showing the reproduction principle of the identification information prerecorded in the NBCA of the L0 layer on the two-layer type optical disc in a second comparison example. FIG. 8 is a schematic top view conceptually showing light transmittance (i) in such an area that the identification information is prerecorded as barcode information, and (ii) in such an area that it is not prerecorded, in the NBCA of the L0 layer on the two-layer type optical disc in the first embodiment of the information recording medium of the present invention. Incidentally, in FIG. 8, the right portion indicates the NBCA divided by the spatial frequency not less than the predetermined spatial frequency, and the left portion indicates the recording area in which the groove track is not divided.

(First Characteristic of Reproduction Principle of Identification Information, Etc.)

Firstly, with reference to FIG. 5 to FIG. 8, the operation and effect will be studied and explained with regard to the first characteristic of (i) the reproduction principle of the identification information in the L0 layer in the first embodiment and (ii) the reproduction principle of the record information in the L1 layer.

As shown in FIG. 5 and FIG. 8 described later, particularly, on the two-layer type optical disc in the first embodiment of the information recording medium of the present invention, for example, at the time of the manufacturing thereof, the groove track is divided in a direction along the groove track by the spatial frequency not less than (or greater than) the predetermined spatial frequency (unit is “the number of tracks per millimeter”) at which the reproduction can no longer be performed on the basis of the optical transfer characteristic (MTF: Modulation Transfer Function) of a reproduction optical system, such as the objective lens of an optical pickup, for example. The “predetermined spatial frequency” herein is determined on the basis of (i) the numerical aperture (NA) of the reproduction optical system, such as the objective lens of the optical pickup, for example, and (ii) the wavelength of the laser light. Specifically, the predetermined spatial frequency “X” is calculated from the following equation (1).
X=2NA/λ (1)

wherein, “NA” is the numerical aperture (NA) of the reproduction optical system, such as the objective lens of the optical pickup, for example, and “λ” is the wavelength of the laser light.

Here, since NA=0.45 and λ=0.78 (μm), X is calculated as X=1153.8462 (unit is “the number of tracks per millimeter”).

More specifically, as shown by a point A in FIG. 6, if the spatial frequency is relatively small, the length of a groove which is one divided unit is relatively large, and the optical transfer characteristic, i.e. a reproduction level, is relatively large and approximates “1”. On the other hand, as shown by a point B in FIG. 6, if the spatial frequency is greater than about “1154”, the length of the groove which is one divided unit is relatively small, and the optical transfer characteristic, i.e. the reproduction level, is “0: zero”.

As described above, a modulation signal obtained from the divided groove track is hardly superimposed or not superimposed at all, on a reproduction RF signal obtained from the identification information prerecorded as the barcode information in the NBCA of the L0 layer in the first embodiment.

As shown by a point C in FIG. 6, for example, if the groove track is divided in the direction along the groove track by 600 (unit is “the number of tracks per millimeter”) which is smaller than the predetermined spatial frequency, the optical transfer characteristic, i.e. the reproduction level, is about “0.5”, and as shown in FIG. 7, the modulation signal obtained from the divided groove track is superimposed on the reproduction RF signal obtained from the identification information prerecorded as the barcode information in the NBCA of the L0 layer.

As opposed to this, in the NBCA of the L0 layer in the first embodiment, the groove track is divided in the direction along the groove track by the spatial frequency not less than the predetermined spatial frequency at which the reproduction can no longer be performed on the basis of the optical transfer characteristic (MTF) of the reproduction optical system. Therefore, it can be said that the modulation signal obtained from the divided groove track is hardly superimposed or not superimposed at all, on the reproduction RF signal obtained from the identification information prerecorded as the barcode information in the NBCA of the L0 layer.

(Second Characteristic of Reproduction Principle of Identification Information, Etc.)

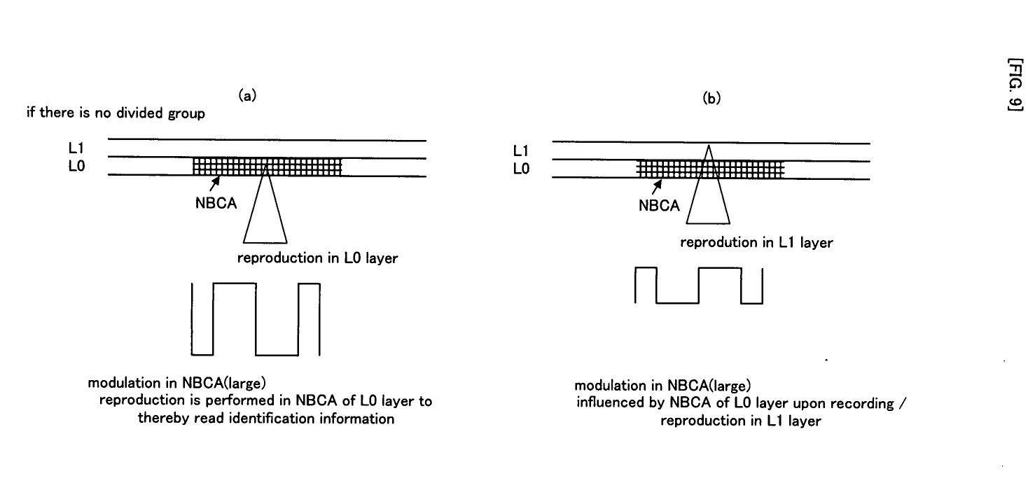

Next, in addition to FIG. 9, with reference to the above-mentioned FIG. 5 to FIG. 8, as occasion demands, the operation and effect will be studied and explained with regard to the second characteristic of (i) the reproduction principle of the identification information in the L0 layer in the first embodiment and (ii) the reproduction principle of the record information in the L1 layer. FIG. 9 are a conceptual cross sectional view showing the reproduction principle of the identification information prerecorded in the NBCA of the L0 layer on the two-layer type optical disc in a third comparison example (FIG. 9(a)), and a conceptual cross sectional view showing the reproduction principle of the record information recorded in the recording area of the L1 layer facing at least one portion of the NBCA (FIG. 9(b)).

As shown in FIG. 8, the first embodiment may be constructed (i) to reduce the amount of pigment in the entire NBCA by adjusting the “predetermined spatial frequency” which divides the groove track and (ii) to set the optical transmittance of a portion BA0 of the NBCA, closer to the optical transmittance (relatively large) of another portion BA1 of the NBCA than the optical transmittance (relatively small) of an area BA0a, wherein (iii) the barcode information for carrying the identification information is not recorded in the portion BA0, and it is assumed in the area BA0a that (iv-1) the groove track is not divided by the spatial frequency and (iv-2) the barcode information is not recorded, and the barcode information is recorded in the portion BA1.

As a result, as shown in FIG. 5(b) described above, if the L1 layer is focused on (if the focal point is on the L1 layer) which is located on the farther side than the L0 layer viewed from the laser light irradiation side, it is possible to almost or completely uniform the optical transmittance of the laser light irradiated on the L0 layer with it defocused (vaguely), averagely as a whole, regardless of (i) the area with the barcode information recorded or (ii) the area without the barcode information in the NBCA of the L0 layer.

If the groove track is not divided in the NBCA, as shown in the left part of FIG. 8 and in FIG. 9(a), it is possible to clearly differentiate the optical transmittance in (i) the area with the barcode information recorded and (ii) the area without the barcode information. Thus, if the identification information prerecorded in the NBCA of the L0 layer is reproduced, the good reproduction RF signal is possibly obtained. However, as shown in FIG. 9(b), with regard to the reproduction RF signal obtained from the record information recorded in the recording area of the L1 layer located on the farther side than the NBCA of the L0 layer, the clear difference in the optical transmittance in the NBCA of the L0 layer greatly influences the modulation signal obtained from the identification information recorded as the barcode information.

As opposed to this, according to the first embodiment, as shown in FIG. 5(b) described above, if the L1 layer is focused on (if the focal point is on the L1 layer) which is located on the farther side than the L0 layer viewed from the laser light irradiation side, it is possible to almost or completely uniform the optical transmittance of the laser light irradiated on the L0 layer with it defocused (vaguely), averagely as a whole, regardless of (i) the area with the barcode information recorded or (ii) the area without the barcode information in the NBCA of the L0 layer. Therefore, it is possible to almost or completely eliminate the influence of the modulation signal, obtained from the identification information recorded as the barcode information in the NBCA of the L0 layer, on the reproduction RF signal obtained from the record information recorded in the recording area of the L1 layer located on the farther side (or rear side) than the NBCA of the L0 layer.

As explained with reference to FIG. 5 to FIG. 9 described above, it is possible to prerecord the identification information, properly and accurately, due to the first and second characteristics of (i) the reproduction principle of the identification information in the L0 layer in the first embodiment and (ii) the reproduction principle of the record information in the L1 layer. In addition, the first and second characteristics allow no influence on the reproduction of the record information recorded in the L1 layer. Therefore, it is possible to effectively use the recording areas of another recording layer including the facing L1 layer.

### Second Embodiment of Information Recording Medium

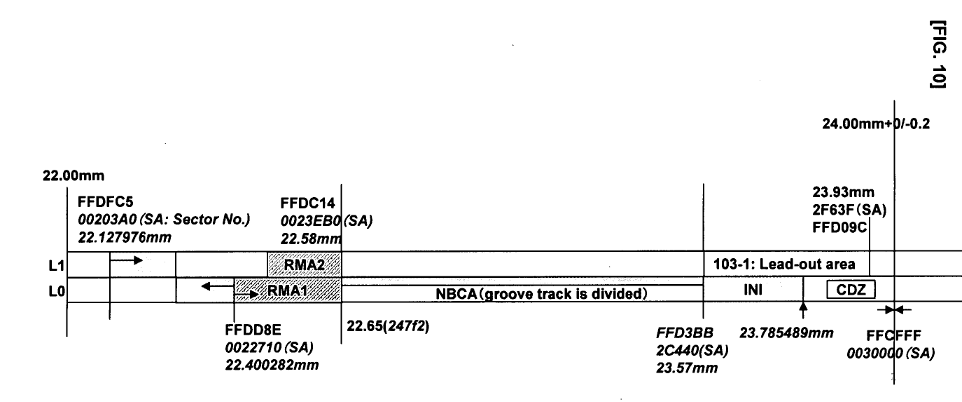

Next, with reference to FIG. 10, an explanation will be given for a detailed data structure centered on (or mainly discussed about) the NBCA of the L0 layer on a two-layer type optical disc in a second embodiment of the information recording medium of the present invention. FIG. 10 is a schematic cross sectional view showing the detailed data structure centered on (or mainly discussed about) the NBCA in the L0 layer on the two-layer type optical disc in the second embodiment of the information recording medium of the present invention.

As shown in FIG. 10, the data structure of an optical disc 100 in the second embodiment is substantially the same as that of the optical disc in the first embodiment.

A lead-in area 101-0 of the L0 layer is provided with: an OPC area PCA0; a first recording management area RMA1; a NBCA; an initial zone INI; and a control data zone CDZ, from the inner to the outer circumferential side.

Specifically, with regard to the OPC area PCA0, the position in the radial direction is 22.127976 to 22.400282 mm, the sector number is 00203A0 to 0022710, and the LPP address is FFDFC5 to FFDD8E.

With regard to the first recording management area RMA1, the position in the radial direction is 22.400282 to 22.58 mm

With regard to the position of the NBCA, the address, and the division of the groove track are the same as those in the first embodiment.

The initial zone INI and the control data zone CDZ are the same as those in the first embodiment.

On the other hand, a lead-in area 101-1 of the L1 layer is provided with: an OPC area PCA1; and a second recording management area RMA2, from the inner to the outer circumferential side.

Specifically, with regard to the OPC area PCA1, the position in the radial direction is 22.127976 to 22.400282 mm, as in the OPC area PCA0.

The second recording management area RMA2 is disposed in the recording area facing the first recording management area RMA1 of the L0 layer.

The position in the radial direction of the innermost edge of the second recording management area RMA2 is shifted to the outer circumferential side by an eccentric amount of 0.2 mm or the like, for example, from the position in the radial direction of the innermost edge of the first recording management area RMA1. On the other hand, with regard to the position in the radial direction of the outermost edge of the second recording management area RMA2, not only it is unnecessary to consider the eccentric amount from the outermost edge of the first recording management area RMA1, but also it can be disposed in the position which is shifted to the inner circumferential side by an eccentric amount of 0.2 mm or the like, for example, from the position in the radial direction of the outermost edge of the NBCA of the L0 layer at most.

As described above, the NBCA with the identification information prerecorded is disposed only in the L0 layer, so that it is possible to dispose the second recording management area RMA2 and the recording area, such as the data area, in the recording areas of the facing L1 layer, to thereby effectively use recording area.

In the above-mentioned embodiments, the write-once type or rewritable type optical disc, such as the two-layer type DVD-R and DVD-R/W, is explained as one example of the information recording medium. The present invention, however, can be applied to a multiple layer type recording media, such as a three layer type and a four layer type, for example. Moreover, it can be also applied to a large-capacity recording medium, such as a Blu-ray disc.

The present invention is not limited to the above-described embodiments, and various changes may be made, if desired, without departing from the essence or spirit of the invention which can be read from the claims and the entire specification. An information recording medium, which involves such changes, is also intended to be within the technical scope of the present invention.

### INDUSTRIAL APPLICABILITY

The information recording medium according to the present invention can be applied to an information recording medium, such as a DVD, for example.

1-7. (canceled)

8. An information recording medium comprising: a plurality of recording layers, each of which is to record therein a plurality of record information,
a first recording layer located on a nearest side viewed from a laser light irradiation side, out of said plurality of recording layers, having an identification information recording area in which identification information for identifying said information recording medium is prerecorded,
each of said plurality of recording layers having a record information recoding area in which a land track and a groove track are alternately formed as a record track for recording the plurality of record information,
in the identification information recording area, the groove track being divided in a direction along the groove track by a spatial frequency not less than a predetermined spatial frequency at which reproduction can no longer be performed on the basis of an optical transfer characteristic of a reproduction optical system.

9. The information recording medium according to claim 8, wherein the identification information is information peculiar to said information recording medium.

10. The information recording medium according to claim 8, wherein the first recording layer, another recording layer or another recording layers out of said plurality of recording layers, has an encryption information recording area to record therein encryption information, which corresponds to the identification information, for encrypting at least one portion of the plurality of record information.

11. The information recording medium according to claim 8, wherein the first recording layer further has a control information recording area in which control information for controlling reproduction and recording of the plurality of record information can be recorded.

12. The information recording medium according to claim 11, wherein flag information indicating whether or not there is the identification information recording area can be recorded in the control information recording area.

13. The information recording medium according to claim 8, wherein the predetermined spatial frequency is determined on the basis of numerical aperture of the reproduction optical system and a wavelength of laser light.
